(19) United States
(12) Patent Application Publication
(10) Pub. No.: US 2013/0181816 A1
(43) Pub. Date: Jul. 18, 2013

(54) MECHANISM AND METHOD FOR RFID CABLE PATH LABELING, IDENTIFICATION, AND INVENTORY

(71) Applicants: William G. Carlson, JR., Hopewell Junction, NY (US); Osvaldo A. Rodriguez, Poughkeepsie, NY (US); Eric C. Wieder, New Paltz, NY (US)

(72) Inventors: William G. Carlson, JR., Hopewell Junction, NY (US); Osvaldo A. Rodriguez, Poughkeepsie, NY (US); Eric C. Wieder, New Paltz, NY (US)

(73) Assignee: INTERNATIONAL BUSINESS MACHINES CORPORATION, Armonk, NY (US)

(21) Appl. No.: 13/351,540

(22) Filed: Jan. 17, 2012

(51) Int. Cl. G06K 7/01

(52) U.S. Cl. 340/10.1

(57) ABSTRACT

The present invention relates to the use of RFID technology to identify the specific location of cable ends in a network configuration. An end of a cable has an attached RFID tag capable of storing cable identification information. The cable end is connected to an endpoint adapter having a means for communicating with the identification adapter in the cable end. A database stores the cable identification information read by the communication means within the endpoint adapter.

### BACKGROUND

The present invention relates generally to identification of cables, and more particularly, the present invention is directed to the identification and tracking of cables, such as those used in computer and communication networks.

Computer and communication networks rely on cables to connect components of the networks to one another. To facilitate troubleshooting, maintenance and reconfiguration of signal paths used within the networks, it is desired that each and every cable be identified as to its origin and termination. This identification includes recordation of each and every connection, including tagging the end of the cable as well as the port it is plugged into. Additionally, some systems have cables that are passively patched and these patch locations must be recorded as well. In networks with a large number of interconnected components, keeping accurate track of and managing the connections becomes a significant effort. Network problems may occur if interconnections are not accurately recorded in a timely manner.

Paper based documentation which relies on written or printed labels on the ends of cables is still typically used for tracking the inventory of these cable connections. With large networks, the documentation may be recorded in the form of record books where each of the connections are manually recorded. Once the manual list of connections is recorded, the data may then additionally be entered manually into a cable inventory database. These manual processes for recording cable data have obvious disadvantages in terms of effort required and potential for error.

More advanced systems for monitoring and recording cable connections exist. For example, a bar code may be placed at both ends of a cable. These scanned bar codes may be used to identify and locate each of the cables in an inventory. This method is less effective when applied to systems incorporating patch panels since only the endpoints of the cable are being tracked and not the entire passive cable path. Additionally, because bar code information is static and cannot be changed, each time a cable is moved the new location must be updated in the records.

Therefore, a need for an automated inventory system exists that can expedite the inventory process, track a whole passive cable path, and reduce human error.

### SUMMARY OF THE INVENTION

According to one embodiment of the invention, a method is provided having a database of information connected to a network. The first end of a cable has an identification adapter that stores cable identification information. A first endpoint adapter is connected to a first device, and is also connected to the first cable end. The first endpoint adapter is capable of communicating with the identification adapter of the attached cable end. The first endpoint adapter reads the cable identification information from the identification adapter. The read cable identification information is then stored in the database.

According to another embodiment of the present invention, a system for identifying the position of a cable is provided having a cable wherein a first identification adapter coupled to the first end of the cable. The first identification adapter stores cable identification information. A first endpoint adapter is connected to the first cable end. The first endpoint adapter is capable of communicating with the first identification adapter. The first endpoint adapter is also connected to a network connected first device. The system also includes a database for storing cable identification information.

According to another embodiment of the present invention, an inventory system for tracking network cables is provided having a plurality of cables. A first cable has a first end with a first identification adapter and a second end with a second identification adapter, and a second cable has a first end with a third identification adapter and a second end with a fourth identification adapter. A first endpoint connected is connected to a first device, and also to a first end of the first cable. The second end of the first cable is connected to an input port of a passive device having a plurality of input ports and output ports. The first end of the second cable is connected to an output port of the passive device, and the second end of the second cable is connected to a second endpoint adapter. The second endpoint adapter is also connected to a second device. The system additionally includes a database for storing information from all of the identification adapters in the system.

### BRIEF DESCRIPTION OF THE DRAWINGS

FIG. 1 is an exemplary cable identification system having a single cable path;

FIG. 2 is an exemplary method for creating and collecting the cable identification information for a cable in the system;

FIG. 3 is an alternate method for creating and collecting the cable identification information for a cable in the system;

FIG. 4 is an exemplary cable identification system having a passive patch device; and

FIG. 5 is an exemplary method for creating and collecting cable identification information for a cable in the system represented in FIG. 4.

### DETAILED DESCRIPTION OF THE DRAWINGS

Exemplary embodiments include systems and method for identifying cables. Throughout the disclosure, a storage area network (SAN) system and cables are discussed for illustrative purposes. It will be appreciated that the systems and method described herein can also be implemented to identify any cable type including optical cables, Ethernet cables, and copper cables. The exemplary systems and methods described herein enable identification of cables regardless of how the cables are connected to the system. As such, the systems and methods described herein identify cables that are either plugged and active or not plugged and inactive. Identification can be implemented for initial correct placement, when hardware components are replaced repaired of upgraded, and for debugging problems related to the cables.

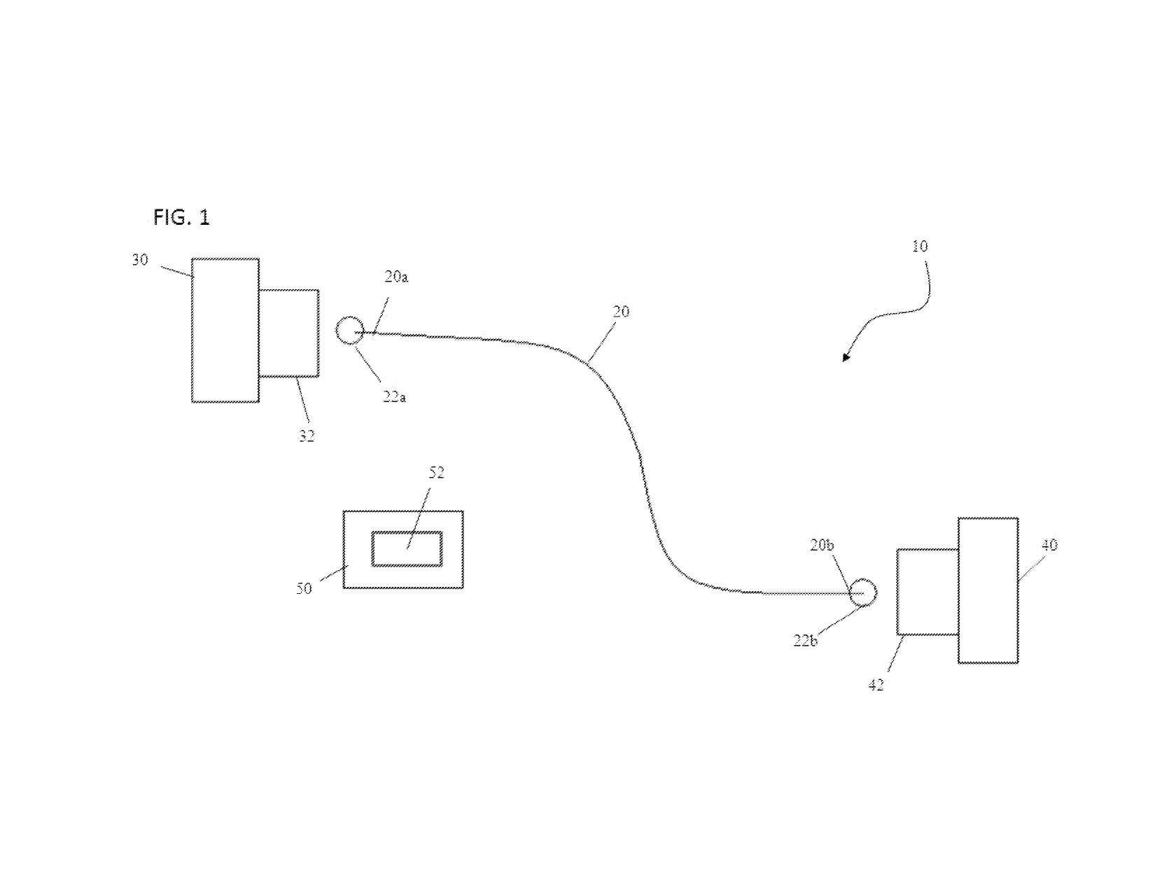

FIG. 1 illustrates an exemplary cable identification system 10. The system 10 may include a first device 30 and a second device 40. It can be appreciated that in the exemplary SAN system, the first device 30 and the second device 40 can be any device in the SAN system. It can also be appreciated that a simplified system having a single cable 20 is shown for illustrative purposes. In the example shown in FIG. 1, the first device 30 can be but is not limited to a SAN switch, or a SAN computer adapter. Similarly, the second device 40 can be but is not limited to a SAN switch or a SAN storage device or disk controller. The system further includes an exemplary SAN cable 20 having an exemplary identification adapter 22 integrated with the cable such that the first end 20a of cable 20 has a first identification adapter 22a, and the second end 20b of cable 20 has a second identification adapter 22b.

The system can further include a first endpoint adapter 32 disposed between the first end 20a of the cable and the first device 30 and a second endpoint adapter 42 disposed between the second end 20b of the cable 20 and the second device 40. The cable 20 is shown as one line for illustrative purposes. Each end 20a, 20b of the cable can plug into the respective endpoint adapter 32, 42. Each of the first endpoint adapter 32 and the second endpoint adapter 42 then plugs into the respective first device 30 and second device 40. For example, the first endpoint adapter 32 and the second endpoint adapter 42 can be a gigabit interface controller (GBIC) or any suitable small for factor pluggable (SFP) device. As such, each of the first endpoint adapter 32 and the second endpoint adapter 42 include connectors that interface directly with the respective first device 30 and second device 40, thereby coupling the cable 20 to the first device 30 and the second device 40. As further described herein, each endpoint adapter is configured to communicate with the identification adapter embedded within the connected cable end. Each endpoint adapter 32, 42 can read information stored on the identification adapter as well as write information to be stored on the identification adapter.

In the exemplary system 10, the first device 30 and the second device 40 are connected to a network. Both the first device 30 and the second device 40 run a utility program within each respective device such that a utility server 50 may access each of the utility programs. The utility server 50 includes a storage database 52 for recording cable path information from each identification adapter. In one embodiment, cable identification information is stored first on each identification adapter and is then recorded in the storage database. In an alternate embodiment, cable identification information is written only to the storage database, not to the identification adapter.

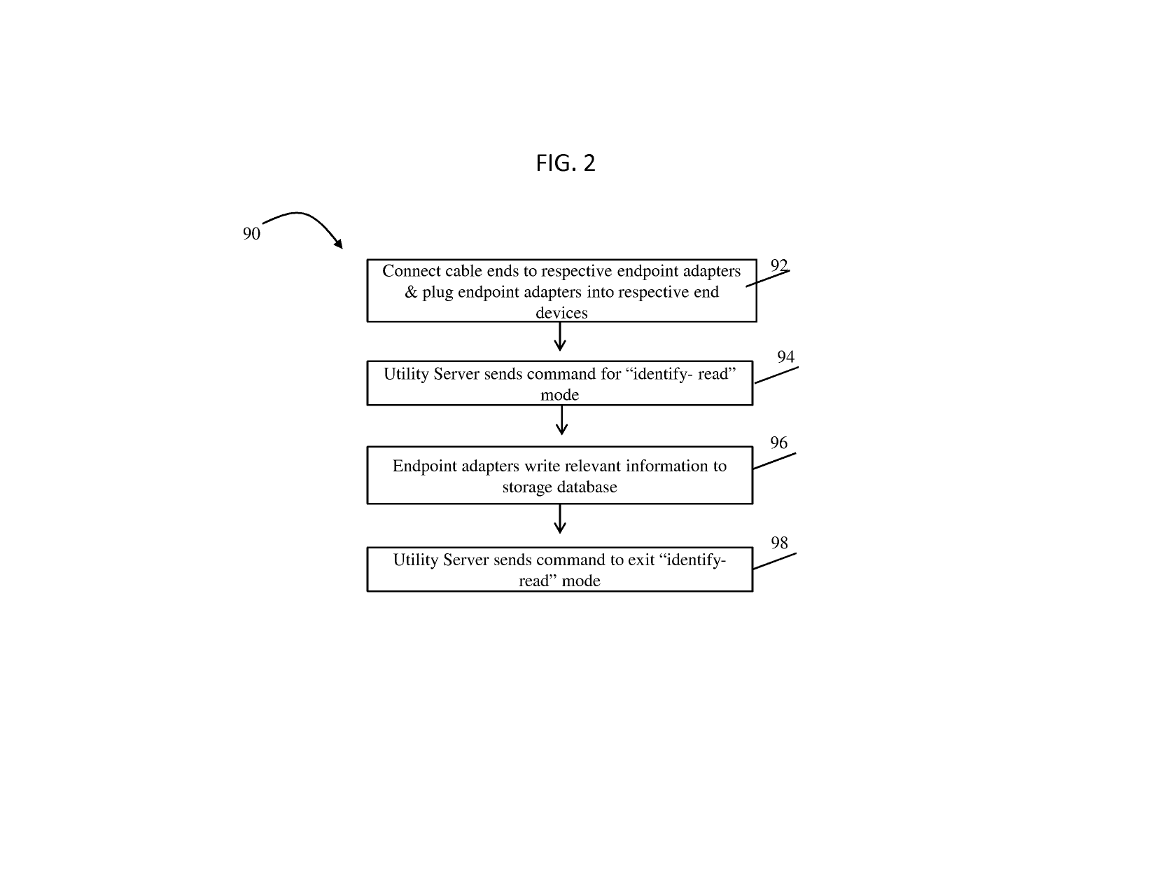

FIG. 2 illustrates a flow chart for a method 90 for identifying and recording the location of a cable in a system where information is written to the storage database and not to the individual identification adapters. At block 92, the first end of a cable is connected to a first endpoint adapter and the second end of a cable is connected to a second endpoint adapter. The first endpoint adapter is connected to a first device, and the second endpoint adapter is connected to a second device. Once the system of cables has been connected, the cable information must be entered into the storage database. At block 94, a utility server, such as utility server 50 for example, sends a command to either the utility program running on the first device or the utility program running on the second device instructing the endpoint adapters enter “identify-read” mode. In this mode, as shown in block 96, the first endpoint adapter and the second endpoint adapter communicate with the identification adapters integrated in their respective connected cable ends to read the static cable identification code. Each endpoint adapter sends relevant cable identification information to the utility server through the utility programs running on the first device and the second device to be stored in the storage database. Once this has been completed, the utility server sends a command to exit the “identify-read” mode, shown in block 98.

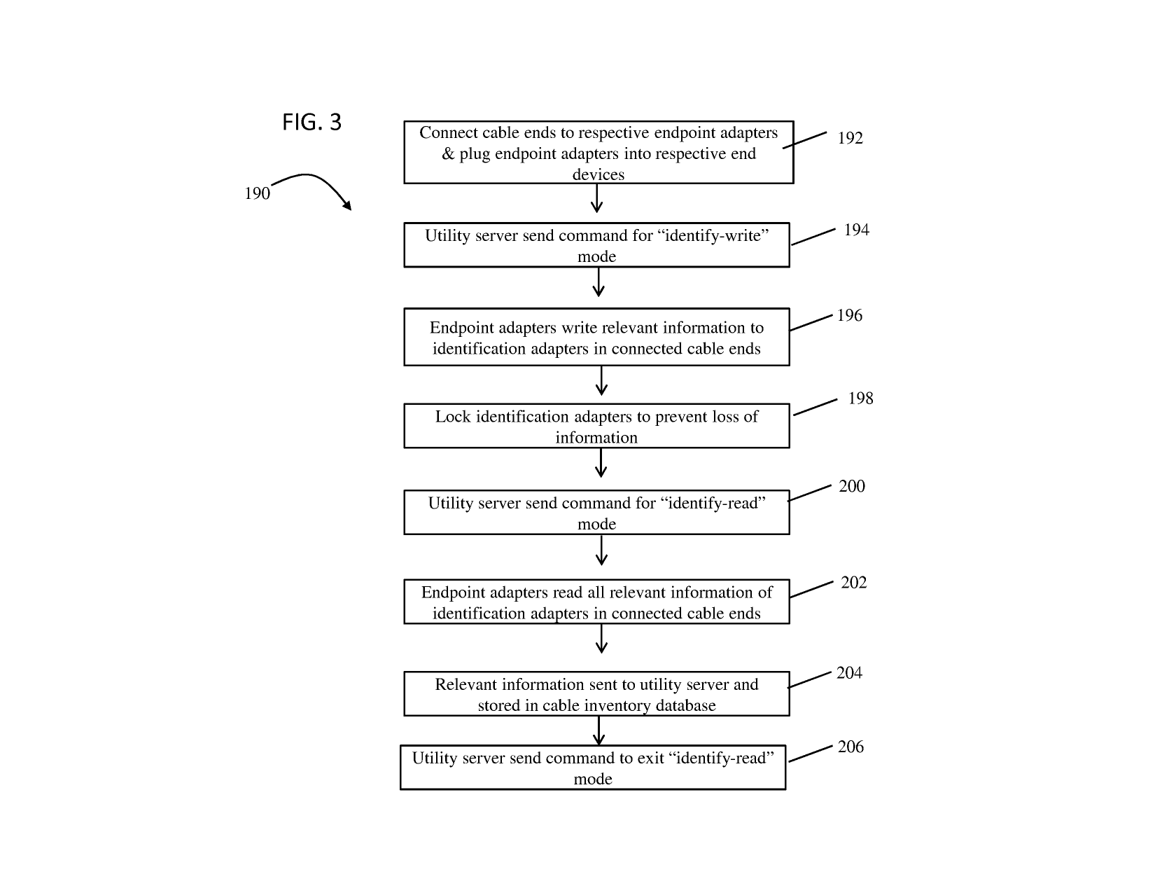

FIG. 3 illustrates a flow chart for a method 190 for identifying and recording the location of a cable in a system where information is written to the identification adapter and is stored on the storage database. Once the cable ends are connected with the first and second endpoint adapters, and the first and second endpoint adapters are plugged into the first and second devices 30, 40 respectively, as shown in block 194, the utility server 50 sends a command to either the utility program of the first device 30 or the utility program of the second device 40 instructing the endpoint adapters to enter “identify-write” mode. In this mode, shown in block 196, the endpoint adapters write relevant cable identification data to the identification adapters integrated in the connected cable ends. In block 198, after the information is written to each identification adapter, each identification adapter is locked to prevent accidental removal or overwriting of information. To harvest the cable identification information stored in each identification adapter, the utility server 50 sends a second command for the endpoint adapters to enter “identify-read” mode. In the “identify-read” mode of block 200, the endpoint adapters read the relevant cable identification information now stored in the identification adapters and pass this data through the running utility programs on the first and second device 30, 40 to the utility server 50. At block 204, the storage database 52 located on the utility server 50 collects and stores this cable identification information. Once all of the information is collected, in block 206 the utility server sends another command to exit “identify-read” mode.

The cable identification information that may be stored directly on each identification adapter and/or on the storage database includes a static cable identification code, a cable path identification code, a local worldwide port name (WWPN), a remote WWPN, a local port identification code, a remote port identification code, a local port equipment or host identification code, a remote port equipment or host identification code, and a plurality of description fields. The cable identification code uniquely identifies each cable and therefore may not be altered by any communication means.

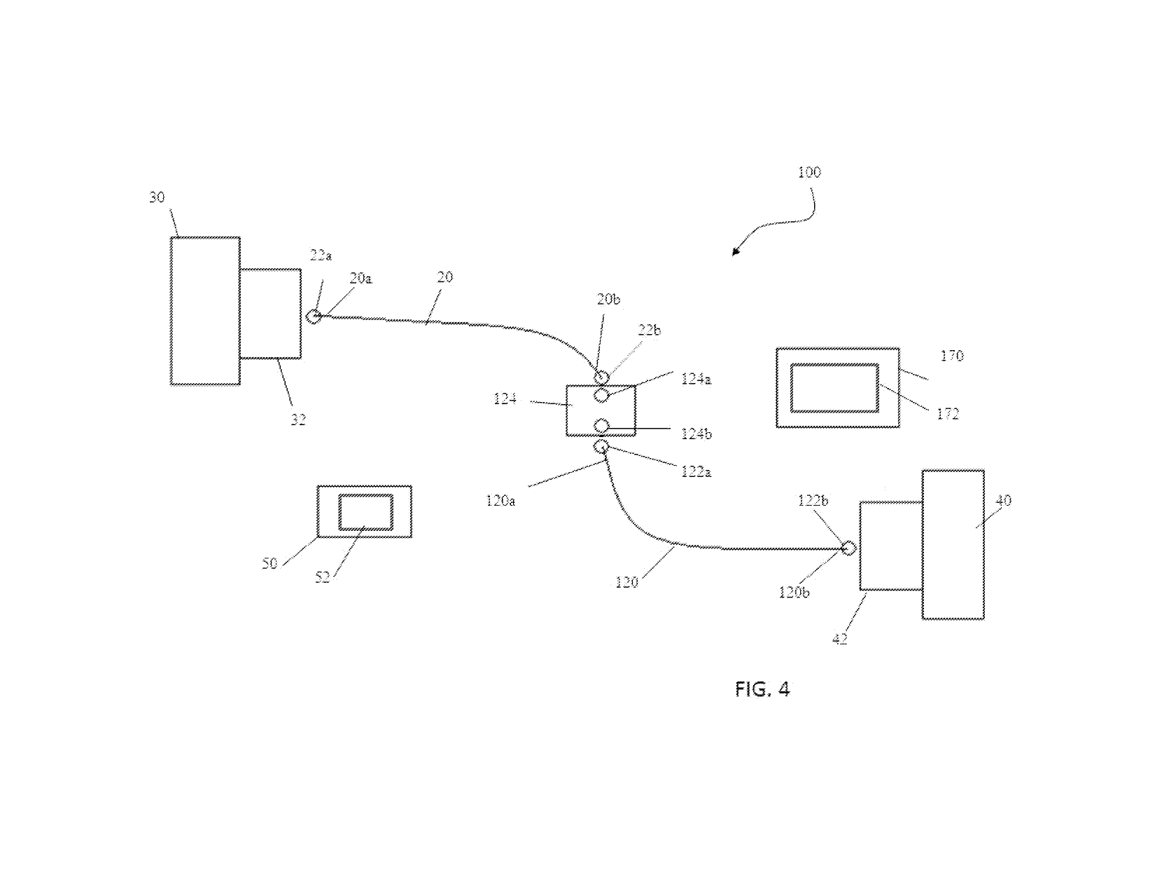

Though the exemplary system of FIG. 1 had only a single cable, the above described system and method for collecting cable information may also be applied to systems having a plurality of cables, as well as systems having a plurality of patch panels. FIG. 4 illustrates an exemplary cable identification system 100. The system 100 is similar to system 10 in FIG. 1, with modifications to further illustrate exemplary embodiments. The system 100 can include the first device 30 and the second device 40. The system 100 can further include the exemplary cable 20, that includes the exemplary identification adapters 22a and 22b within the cable. The system 100 can further include the first endpoint adapter 32 disposed between the first end 20a of the cable 20 and the first device 30. However, in the system 100, the cable end 20b is plugged directly into passive patch panel 124, which allows re-routing and re-using of cables. In one embodiment of the invention, each connection port of the patch panel 124 includes an identification adapter, for instance identification adapter 124a is located in an input port and identification adapter 124b is located in an output port. The system 100 can further include an additional cable 120 that includes exemplary identification adapters 122a and 122b embedded in the two ends of the cable. The additional cable 120 has the same features as cable 20 described herein. The system 100 further includes the second endpoint adapter 42 disposed between the second end 120b of cable 120 and the second device 40. The cable 120 is further directly plugged into the passive patch panel 124 at a first end 120a. It can be appreciated that the exemplary system of FIG. 4 is simplified for illustrative purposes. Alternate systems may include a plurality of cables as well as a plurality of patch panels.

The system may also include a portable, handheld device 170, such as a personal digital assistant or smartphone, which has been modified to include a communication device 172 that is capable of reading information from and writing information to an identification adapter. This handheld device 170 may be used at passive or non-network connected locations in the system, such as at patch panel 124. Similar to the endpoint adapters 32, 42, the handheld device is connected to the network and may be accessed by the utility server 50 through a utility program run on the device.

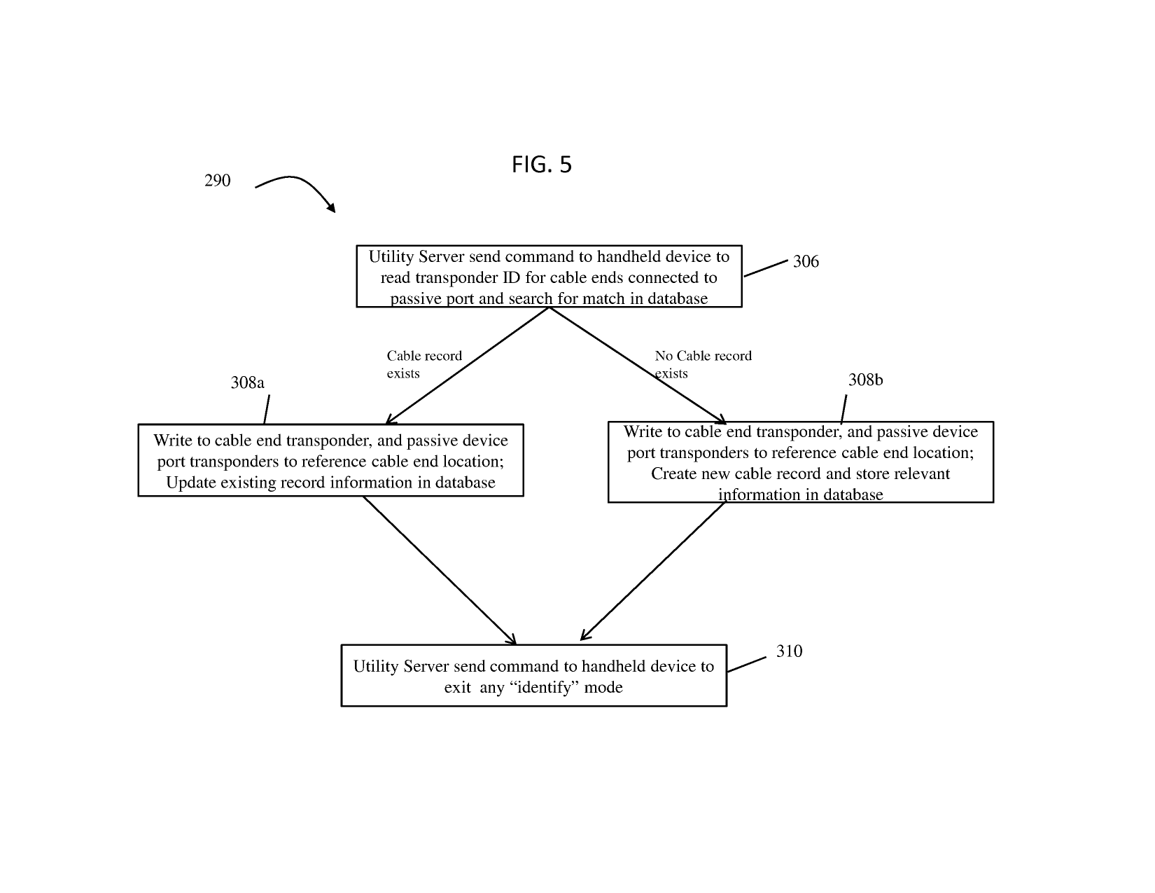

With reference to FIG. 5, the process 290 for creating and recording the locations of cable ends in a system having a passive patch panel connected to a handheld device 170 is shown. This process is similar to the methods 90, 190 shown in FIGS. 2 and 3, such that the steps of method 290 may be added after step 96 of method 90 or after step 204 of method 190, before the utility server sends a command to exit the “identify-read” mode. If the information is being stored directly to the database 52, the process will follow method 90, and if the information is being written first to the identification adapters, the process will follow method 190. The handheld device 170 has a utility program running thereby allowing the handheld device to communicate with the utility server 50. Cables and endpoint adapters that are in “identify-read” or “identify-write” mode are visible to the handheld device's 170 communication device 172. Once the cable identification information has been recorded for the cable ends connected to the endpoint adapters, in block 306, the handheld device 170 reads the static cable identification code from an identification adapter connected to a passive patch panel, such as patch panel 124, and searches for information on the cable in the storage database 52. If a record of the cable exists in the database, as shown in block 308a, the handheld device 170 uses communication device 172 to read the identification adapters associated with the input or output port where the cable end is connected. The communication device 172 will then write relevant information either directly to the identification adapter of the port and the connected cable end, or to the storage database 52 to identify the port location of the cable end. By associating the cable with a port, the handheld device may reference the physical location of the end of the cable, and this information may be recorded into the database 52. If the cable does not exist in the database, a new cable entry will be created, as shown in block 308b. The communication means 172 in the handheld device will write the relevant information either to the identification adapter or to the storage database. If information is stored directly to the identification adapters in the system, once the information has been written, the identification adapter will be locked, and the information will be sent to the utility server 50 to be stored in the database 52. Once the cable information is stored or updated in the database, in block 310, the utility server sends a command to the handheld device to exit any “identify” mode that handheld device may have run.

Once the inventory database 52 is fully created, the records of location of each cable end may be used to determine placement of cables that have been unplugged. In one embodiment of the invention, a device, such as handheld device 170 having communication means 172, could be used to scan an identification adapter in an unconnected end of the cable. This device could then use the information recorded in the database to determine what port the cable end should be connected to. Additionally, the system may be used to track faulty cables. By taking an inventory or “reading” of the locations of all cable ends and comparing the results with the previously recorded data stored in the database 52, discrepancies in the information may be identified and may indicate errors such as a faulty identification adapter or an unplugged cable.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A system for identifying the position of a cable comprising:
a cable having a first end with a first identification adapter, the first identification adapter containing cable identification information;
a first endpoint adapter connected to the first end, the first endpoint adapter being configured to communicate with the first identification adapter;
a network connected first device connected to the first endpoint adapter; and
a database for storing the cable identification information.

2. The system for identifying the position of a cable according to claim 1, wherein the first identification adapter is integrated with the first end of the cable.

3. The system for identifying the position of a cable according to claim 1, wherein the first identification adapter is an RFID tag.

4. The system for identifying the position of a cable according to claim 1, wherein the cable is a network cable.

5. The system for identifying the position of a cable according to claim 1, wherein the first endpoint adapter is a GBIC SFP.

6. The system for identifying the position of a cable according to claim 1, wherein the first endpoint adapter can write cable identification information to the first identification adapter, lock the first identification adapter to prevent editing, and read cable identification information stored on the first identification adapter.

7. The system for identifying the position of a cable according to claim 1, further comprising:
the cable having a second cable end with a second identification adapter for storing cable identification information; and
a second endpoint adapter connected to the second cable end, the second endpoint adapter being configured to communicate with the second identification adapter.

8. The system according to claim 7, wherein the first endpoint adapter is connected to a first device, the second endpoint adapter is connected to a second device, and the cable connects the first device and the second device.

9. The system according to claim 8, wherein the first device and the second device may be selected from a group of devices including a computer device, a storage area network device and a storage device.

10. The system according to claim 1, wherein the database is connected to a network.

11. The system according to claim 1, wherein the cable identification information stored in the database may be used to determine placement for an unconnected cable end.

12. The system according to claim 1, wherein the cable identification information stored in the database may be used to detect a faulty cable.

13. A system comprising:
a first cable having a first end with a first identification adapter and a second end having a second identification adapter;
a second cable having a first end with a third identification adapter and a second end having a fourth identification adapter;
a first device connected to a first endpoint adapter, the first endpoint adapter also being connected to the first end of the first cable;
a passive device having a plurality of input ports and a plurality of output ports, the passive device being connected to the second end of the first cable and to the first end of the second cable;
a second device connected to a second endpoint adapter, the second endpoint adapter also being connected to the second end of the second cable; and
a database for storing information from all of the identification adapters in the system.

14. The system according to claim 13, wherein the first identification adapter and the second identification adapter of the first cable and the third identification adapter and the fourth identification adapter of the second cable are RFID tags.

15. The system according to claim 13, wherein each input port and each output port on the passive device has an associated RFID tag.

16. A method for tracking cable inventory comprising:
providing a database of information connected to a network;
providing a cable having a first end with an identification adapter for storing cable identification information;
providing a first endpoint adapter connected to the first end, the first endpoint adapter also connected to a first device and being configured to communicate with the identification adapter;
reading the cable identification information stored on the identification adapter; and
storing the cable identification information in a database.

17. The method according to claim 16, wherein the identification adapter is integrated with the first end of the cable.

18. The method according to claim 16, wherein the cable is a network cable.

19. The method according to claim 16, wherein the identification adapter is a radio frequency identification (RFID) tag.

20. The method according to claim 16, wherein the first endpoint adapter is a gigabit interface converter or small form factor pluggable transceiver (GBIC SFP).
